(19) United States
(12) Patent Application Publication
(10) Pub. No.: US 2017/0169456 A1
(43) Pub. Date: Jun. 15, 2017

(54) METHODS AND SYSTEMS OF COST DETERMINATION OF COMPUTATIONAL RESOURCES

(71) Applicant: XEROX CORPORATION, Norwalk, CT (US)

(72) Inventor: Tridib Mukherjee, Bangalore (IN)

(21) Appl. No.: 14/969,131

(22) Filed: Dec. 15, 2015

(51) Int. Cl. G06Q 30/02

(52) U.S. Cl. CPC G06Q 30/0206

(57) ABSTRACT

A method and system of cost determination of one or more computational resources is described. The method receives a first information pertaining to one or more available computational resources from one or more resource providers and further receives one or more requests pertaining to one or more required computational resources from one or more requestors. Based on at least a comparison of the first information and the second information and a first cost and a second cost associated with the one or more required computational resources in a previous time epoch, the disclosed method determines, in a current time epoch, a first cost offered to the one or more requestors for the one or more required computational resources and a second cost offered to the one or more resource providers for providing the one or more required computational resources.

### TECHNICAL FIELD

The presently disclosed embodiments relate in general to cloud-computing. More particularly, the presently disclosed embodiments relate to methods and systems of cost determination of one or more computational resources in a shared service marketplace.

### BACKGROUND

With ever-increasing advancements in the field of cloud-computing based environment, the demand for shared service based platforms is increasing at a rapid rate. The shared service based platforms facilitate resource providers to share one or more computational resources. Further, the shared service based platforms allow resource users to choose from the shared one or more computational resources as per their requirements. Examples of the one or more computational resources may include, but are not limited to, one or more processor instances, storage space, and RAM memory space.

The shared service based platforms need to ensure certain price options to the resource providers in exchange of sharing the one or more computational resources. The shared service based platforms further need to ensure attractive price options for the resource users to encourage their interest in the one or more computational resources. Generally, the price at one end (e.g., resource providers) is fixed and based on the fixed price, the price at other end (e.g., resource users) is determined. However, such a system may not be acceptable to the resource providers as well as the resource users all the time. Therefore, there is a need of a robust and efficient model for cost determination of the one or more computational resources.

Further limitations and disadvantages of conventional and traditional approaches will become apparent to one of skill in the art, through comparison of described systems with some aspects of the present disclosure, as set forth in the remainder of the present application and with reference to the drawings.

### SUMMARY

According to embodiments illustrated herein, there is provided a method of cost determination of one or more computational resources. The disclosed method includes receiving, by one or more processors, a first information pertaining to one or more available computational resources from one or more resource provider computing devices. The disclosed method further includes receiving, by the one or more processors, one or more requests pertaining to one or more required computational resources from one or more requestor computing devices. The disclosed method further includes generating, by the one or more processors, a second information for a time epoch from one or more time epochs. The second information may pertain to the one or more required computational resources based on the one or more requests. The disclosed method further includes comparing, by the one or more processors, the second information pertaining to the one or more required computational resources with the first information pertaining to the one or more available computational resources. The disclosed method further includes determining, by the one or more processors, a first cost offered to one or more requestors for the one or more required computational resources and a second cost offered to one or more resource providers for providing the one or more required computational resources. The first cost and the second cost are determined based on at least the comparison, and the first cost and the second cost associated with the one or more required computational resources in a previous time epoch.

According to embodiments illustrated herein, there is provided a system for determining cost of one or more computational resources. The system comprises of one or more processors configured to receive a first information pertaining to one or more available computational resources from one or more resource provider computing devices. The one or more processors are further configured to receive one or more requests pertaining to one or more required computational resources from one or more requestor computing devices. The one or more processors are further configured to generate a second information for a time epoch from one or more time epochs. The second information may pertain to the one or more required computational resources based on the one or more requests. The one or more processors are further configured to compare the second information pertaining to the one or more required computational resources with the first information pertaining to the one or more available computational resources. The one or more processors are further configured to determine a first cost offered to one or more requestors for the one or more required computational resources and a second cost offered to one or more resource providers for providing the one or more required computational resources. The first cost and the second cost are determined based on at least the comparison, and the first cost and the second cost associated with the one or more required computational resources in a previous time epoch.

According to embodiments illustrated herein, there is provided a computer program product for use with a computing device. The computer program product comprises a non-transitory computer readable medium storing a computer program code for determining cost of one or more computational resources. The computer program code is executable by one or more processors in the computing device to receive a first information pertaining to one or more available computational resources from one or more resource provider computing devices. The computer program code is further executable by the one or more processors in the computing device to receive one or more requests pertaining to one or more required computational resources from one or more requestor computing devices. The computer program code is further executable by the one or more processors in the computing device to generate a second information for a time epoch from one or more time epochs. The second information may pertain to the one or more required computational resources based on the one or more requests. The computer program code is further executable by the one or more processors in the computing device to compare the second information pertaining to the one or more required computational resources with the first information pertaining to the one or more available computational resources. The computer program code is further executable by the one or more processors in the computing device to determine a first cost offered to one or more requestors for the one or more required computational resources and a second cost offered to one or more resource providers for providing the one or more required computational resources. The first cost and the second cost are determined based on at least the comparison, and the first cost and the second cost associated with the one or more required computational resources in a previous time epoch.

### BRIEF DESCRIPTION OF DRAWINGS

The accompanying drawings illustrate various embodiments of systems, methods, and other aspects of the disclosure. Any person having ordinary skill in the art will appreciate that the illustrated element boundaries (e.g., boxes, groups of boxes, or other shapes) in the figures represent one example of the boundaries. It may be that in some examples, one element may be designed as multiple elements or that multiple elements may be designed as one element. In some examples, an element shown as an internal component of one element may be implemented as an external component in another, and vice versa. Furthermore, elements may not be drawn to scale.

Various embodiments will hereinafter be described in accordance with the appended drawings, which are provided to illustrate, and not to limit the scope in any manner, wherein like designations denote similar elements, and in which:

FIG. 1 is a block diagram of a system environment, in which various embodiments can be implemented;

FIG. 2 is a block diagram of a marketplace server, in accordance with an embodiment of the disclosure;

FIG. 3 is a flowchart that illustrates a method for determining cost of one or more computational resources, in accordance with at least one embodiment; and

FIG. 4 is an exemplary flow diagram for determining cost of one or more computational resources in one or more time epochs, in accordance with at least one embodiment.

### DETAILED DESCRIPTION

The present disclosure is best understood with reference to the detailed figures and description set forth herein. Various embodiments are discussed below with reference to the figures. However, those skilled in the art will readily appreciate that the detailed descriptions given herein with respect to the figures are simply for explanatory purposes as the methods and systems may extend beyond the described embodiments. For example, the teachings presented and the needs of a particular application may yield multiple alternate and suitable approaches to implement the functionality of any detail described herein. Therefore, any approach may extend beyond the particular implementation choices in the following embodiments described and shown.

References to “one embodiment”, “an embodiment”, “at least one embodiment”, “one example”, “an example”, “for example” and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in an embodiment” does not necessarily refer to the same embodiment.

Definitions: The following terms shall have, for the purposes of this application, the respective meanings set forth below.

A “computing device” refers to a device that includes one or more processors/microcontrollers and/or any other electronic components, a device, or a system that performs one or more operations according to one or more programming instructions, algorithms, programs, or codes. Examples of the computing device may include, but are not limited to, a desktop computer, a laptop, a PDA, a mobile device, a smartphone, a tablet computer (e.g., iPad® and Samsung Galaxy Tab®), and/or the like.

A “computational resource” refers to a resource utilized by a computing device to perform an operation. In an embodiment, the computational resource may correspond to various types of resources such as, but are not limited to, processor instances, storage space, and RAM space. In an embodiment, a virtual machine may include virtual computational resources such as processor instances, storage space, and RAM space that can be loaned out to a consumer for the purpose of executing one or more tasks.

A “cost” corresponds to an amount, either monetary or non-monetary, associated with one or more computational resources. In an embodiment, the cost may correspond to a cost incurred by the one or more requestors to use the one or more computational resources. Such cost has been referred to as a first cost. In another embodiment, the cost may further correspond to a payment that the one or more resource providers may receive for sharing the one or more computational resources with the one or more requestors. In an embodiment, such payment received by the one or more resource providers has been referred to as a second cost.

A “shared service marketplace” refers to a common platform for sharing and/or utilization of one or more computational resources. The one or more computational resources may be shared by one or more resource providers in exchange of certain amount of incentives. Further, the one or more computational resources may be utilized by one or more requestors for performing one or more tasks. The shared service marketplace may facilitate the one or more requestors to utilize the one or more computational resources based on an acceptance of a cost associated with the one or more computational resources. In an embodiment, an administrator associated with the shared service marketplace may be involved in deciding upon the cost of the one or more computational resources based on at least a demand, supply, and/or cost offered to the one or more resource providers for providing the one or more computational resources.

A “resource provider” refers to an individual or an entity who may be interested in renting, selling, or sharing one or more computational resources with one or more requestors. In an embodiment, the resource provider may rent, sell, or share the one or more computational resources with the one or more requestors by use of a shared service marketplace in exchange of certain amount of incentives (either monetary or non-monetary). In an embodiment, the resource provider may correspond to a data center that may have a pool of the one or more computational resources. The pool of the one or more computational resources may be shared with the one or more requestors in form of virtual machines, storage space, etc.

A “requestor” refers to an individual who may require one or more computational resources to perform one or more tasks. In an embodiment, the requester may transmit a request to a shared service marketplace for the one or more computational resources that may be essential to perform the one or more tasks. Further, the requestor may receive the one or more computational resources from one or more resource providers through the shared service marketplace based on at least a service level agreement (SLA) associated with the one or more computational resources. Hereinafter, “requestor”, “customer”, “consumer”, “client”, or “user” may be interchangeably used.

A “service level agreement (SLA)” refers to an agreement between at least two entities when there is an exchange of at least one computational resource between the at least two entities (e.g., a resource provider, a requestor, and/or a shared service marketplace). For example, a requestor may indulge into a SLA with a shared service marketplace based on sharing of one or more computational resources. In an embodiment, the SLA may define a time period associated with a computational resource, a cost associated with the computational resources, and/or the like.

A “task” refers to an application or software that a requester may want to get executed. The requester may request for one or more computational resources for performing the task. Each task may have different computational resource requirement. For example, a first task may be a big data application that is disk space intensive, thereby requiring more disk space resource. Whereas a second task may be a map-reduce application that is compute intensive and thus requires more number of processors.

A “first information” refers to information associated with one or more computational resources that may be provided by one or more resource providers. In an embodiment, the one or more resource providers may provide the first information for each of the one or more computational resources. The first information of a computational resource may include, but are not limited to, a capacity (measured in one of Giga Instructions per second (GIPS), Giga bytes (GB), and/or the like), a minimum cost, and/or the like.

A “request” refers to an input or a message that may include a task to be executed. In an embodiment, the request may include requirements for one or more computational resources for processing the task. In an embodiment, the request may include data pertaining to a type of the task, a minimum cost bearable by a requestor, a maximum cost bearable by the requestor to get the task executed. In an embodiment, the request may correspond to one or more types. In an embodiment, a type of the request may be determined based on the associated task. For example, a first request, which corresponds to an image processing task, may be referred to as a first type request. In an embodiment, the requestor may utilize a computing device to submit the request.

A “second information” refers to information that may be indicative of one or more computational resources that may be required by a requestor to perform or process a task. In an embodiment, the second information may be determined based on at least one or more requests received from the requestor. In an embodiment, the second information may include, but are not limited to, a capacity requirement (e.g., 1 GB, 10 TB, etc.), a processor requirement (e.g., 4-bit processors, 8-bit processors, 16-bit processors, 32-bit processors, 64-bit processors, and/or the like), a RAM requirement (e.g., 1 GB, 2 GB, 3 GB, 4 GB, etc.), and/or the like.

A “time epoch” refers to a time period during which a cost associated with each of one or more computational resources (available and required) is constant. However, the cost of the one or more computational resources may vary across other time epochs. In an embodiment, the cost of a computational resource in a next time epoch may be different than that the cost of the computational resource in the current time epoch. Further, the cost of the computational resource in the current time epoch may depend on at least the cost of the computational resource in a previous time epoch.

“Probability” shall be broadly construed, to include any calculation of probability; approximation of probability, using any type of input data, regardless of precision or lack of precision; any number, either calculated or predetermined, that simulates a probability; or any method step having an effect of using or finding some data having some relation to a probability.

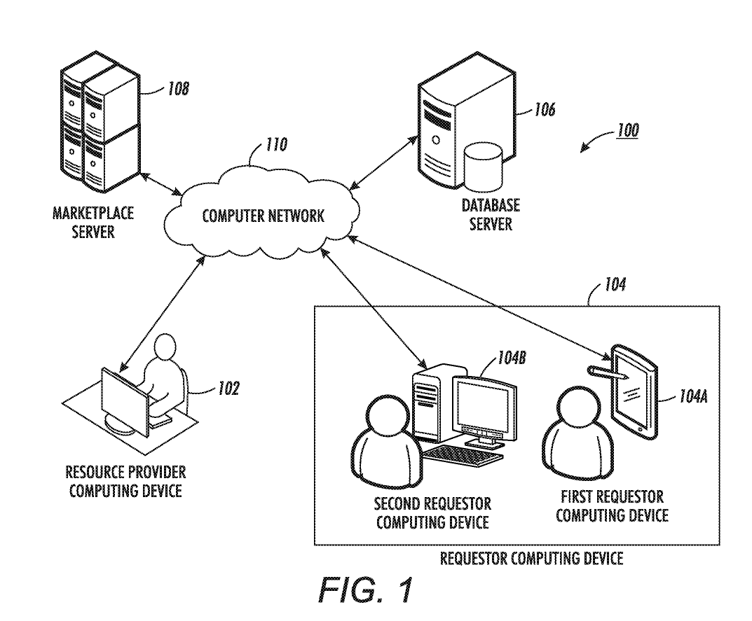

FIG. 1 is a block diagram of a system environment 100 in which various embodiments may be implemented. The system environment 100 includes a resource provider computing device 102, a requestor computing device 104, a database server 106, a marketplace server 108, and a computer network 110. Various devices in the system environment 100 may be interconnected over the computer network 110. FIG. 1 shows, for simplicity, one resource provider computing device 102, two requestor computing devices, such as a first requestor computing device 104A and a second requestor computing device 104B, one database server 106, and one marketplace server 108. However, it will be apparent to a person having ordinary skills in the art that the disclosed embodiments may also be implemented using multiple resource provider computing devices, multiple requestor computing devices, multiple database servers, and multiple marketplace servers without departing from the scope of the disclosure.

The resource provider computing device 102 refers to a computing device that is used by a resource provider. The resource provider may correspond to an individual, a sales person, or an artificial entity such as an organization or a franchise who may be interested to sell, rent, or share one or more available computational resources with one or more consumers (i.e., one or more requestors). The one or more available computational resources may include, but are not limited to, processor instances, storage space, RAM space, and/or the like.

In an embodiment, the resource provider computing device 102 may comprise one or more processors in communication with one or more memories. The resource provider computing device 102 may be operable to execute one or more sets of instructions stored in the one or more memories. In an embodiment, the resource provider computing device 102 may be communicatively coupled to the computer network 110. In an embodiment, the resource provider computing device 102 may comprise a display screen that may be configured to display one or more user interfaces to one or more resource providers.

In an embodiment, the one or more resource providers may utilize corresponding one or more resource provider computing devices, such as the resource provider computing device 102, to share the one or more available computational resources with the marketplace server 108. In an embodiment, the one or more resource providers may transmit a first information associated with each of the one or more available computational resources to the marketplace server 108. The first information may include, but are not limited to, a type and a capacity associated with the one or more available computation resources. Further, in an embodiment, the one or more resource providers may utilize the resource provider computing device 102 to input a minimum threshold cost and a maximum threshold cost for each of the one or more available computational resources. The minimum threshold cost may correspond to a minimum cost that may be charged by the one or more resource providers for sharing, renting, or selling the one or more available computational resources with the marketplace server 108 or the one or more requestors. Such minimum threshold cost of an available computational resource has been referred to as a first threshold cost. The maximum threshold cost may correspond to a maximum cost that may be charged by the one or more resource providers for sharing, renting, or selling the one or more available computational resources with the marketplace server 108 or the one or more requestors. Such maximum threshold cost of an available computational resource has been referred to as a second threshold cost. In an embodiment, the one or more resource providers may change the first threshold cost and the second threshold cost based at least a demand for the one or more available computational resources and a time in a day for such demand.

Further, each of the one or more resource providers may be presented with a user interface on the display screen of the resource provider computing device 102. The user interface may display at least a second cost, which is offered to the one or more resource providers for each of the one or more available computational resources.

The resource provider computing device 102 may correspond to various types of computing devices such as, but are not limited to, a desktop computer, a laptop, a PDA, a mobile device, a smartphone, a tablet computer (e.g., iPad® and Samsung Galaxy Tab®), a data center, and/or the like. A person having ordinary skills in the art will appreciate that the scope of the disclosure is not limited to a data center that hosts the one or more computational resources. Such data center may be implemented using one or more technologies known in the art such as, Eucalyptus™M, and VMware Sphere™.

The requestor computing device 104 refers to a computing device that is used by a requestor. The requestor may correspond to an individual, or an artificial entity such as an organization who may be interested to buy, rent, or request for one or more required computational resources from the marketplace server 108 or the one or more resource providers. The requestor may require the one or more required computational resources to perform one or more tasks. For example, a requestor has “30 GB” of personal photographs. Further, the requestor has shortage of memory on his/her personal computing device. In such a case, the requestor may request (i.e. buy, rent, or share) for the “30 GB” of cloud storage. In an embodiment, the requestor may utilize the requestor computing device 104 to transmit the request to the marketplace server 108 over the computer network 110.

In an embodiment, the requestor computing device 104 may comprise one or more processors in communication with one or more memories. The requestor computing device 104 may be operable to execute one or more sets of instructions stored in the one or more memories. In an embodiment, the requestor computing device 104 may be communicatively coupled to the computer network 110. In an embodiment, the requestor computing device 104 may comprise a display screen that may be configured to display one or more user interfaces to the one or more requestors.

In an embodiment, the one or more requestors may utilize the corresponding one or more requestor computing devices, such as the requestor computing device 104, to transmit one or more requests, for the one or more required computational resources, to the marketplace server 108 or the resource provider computing device 102 over the computer network 110. In an embodiment, the one or more requests may include the task to be performed or executed, the data pertaining to a type of the task, a minimum threshold of the cost that is bearable by the one or more requestors, a maximum threshold of the cost that is bearable by the one or more requestors.

Further, each of the one or more requestors may be presented with a user interface on the display screen of the requestor computing device 104. The user interface may display at least a first cost for each of the one or more required computational resources.

The requestor computing device 104 may correspond to various types of computing devices such as, but are not limited to, a desktop computer, a laptop, a PDA, a mobile device, a smartphone, a tablet computer (e.g., iPad® and Samsung Galaxy Tab®), and/or the like.

The database server 106 may refer to a computing device that may be configured to store cost information of one or more computational resources (available and required computational resources) that may have been shared with the one or more requestors in the past. Further, the database server 106 may store a profile information of each of the one or more resource providers and each of the one or more requestors who may have been associated with the marketplace server 108 in the past. The profile information may include one or more of: name, type of available/required computational resources, available/required duration for each of the one or more computational resources, a cost pattern of each of the one or more resource providers and one or more requestors for the one or more computational resources, and/or the like. In an embodiment, the database server 106 may further store the first cost of each of the one or more required resources and the second cost of each of the one or more available resources. In an embodiment, the first cost and the second cost may be associated with one or more time epochs. In an embodiment, the first cost and the second cost are constant during each of the one or more time epochs.

In an embodiment, the database server 106 may be communicatively coupled to the computer network 110. In an embodiment, the database server 106 may receive a query from the marketplace server 108 to retrieve the information pertaining to the one or more resource providers and one or more requestors. For querying the database server 106, one or more querying languages may be utilized such as, but not limited to, SQL, QUEL, DMX and so forth. Further, the database server 106 may be realized through various technologies such as, but not limited to, Microsoft® SQL server, Oracle, and My SQL.

The marketplace server 108 refers to a computing device that may include one or more processors and one or more memories. The one or more memories may include computer readable codes that are executable by the one or more processors to perform one or more predefined operations. For example, the one or more predefined operations may include, but are not limited to, receiving the first information pertaining to the one or more available computational resources from the resource provider computing device 102, receiving the one or more requests from the requestor computing device 104, generating the second information pertaining to the one or more required computational resources based on the one or more requests, determining the first cost during a time epoch that may be offered to the one or more requestors for the one or more required computational resources, and the second cost during the time epoch that may be offered to the one or more resource providers for providing the one or more required computational resources. The one or more predefined operations may further include updating the first cost and the second cost based on a probability of acceptance of the first cost and the second cost by the one or more requestors and the one or more resource providers, respectively.

The marketplace server 108 may be realized through various types of application servers such as, but not limited to, Java application server, .NET framework application server, and Base4 application server.

A person having ordinary skill in the art will understand that the scope of the disclosure is not limited to the database server 106 or the marketplace server 108 as a separate entity. In an embodiment, the functionalities of the database server 106 may be integrated into the marketplace server 108 without departing from the spirit of the disclosure.

The computer network 110 may include a medium through which devices, such as the resource provider computing device 102 and the requestor computing device 104 and one or more servers, such as the database server 106 and the marketplace server 108 may communicate with each other. Examples of the computer network 110 may include, but are not limited to, the Internet, a cloud network, a Wireless Fidelity (Wi-Fi) network, a Wireless Local Area Network (WLAN), a Local Area Network (LAN), a plain old telephone service (POTS), and/or a Metropolitan Area Network (MAN). Various devices in the system environment 100 may be configured to connect to the computer network 110, in accordance with various wired and wireless communication protocols. Examples of such wired and wireless communication protocols may include, but are not limited to, Transmission Control Protocol and Internet Protocol (TCP/IP), User Datagram Protocol (UDP), Hypertext Transfer Protocol (HTTP), File Transfer Protocol (FTP), ZigBee, EDGE, infrared (IR), IEEE 802.11, 802.16, cellular communication protocols, such as Long Term Evolution (LTE), and/or Bluetooth (BT) communication protocols.

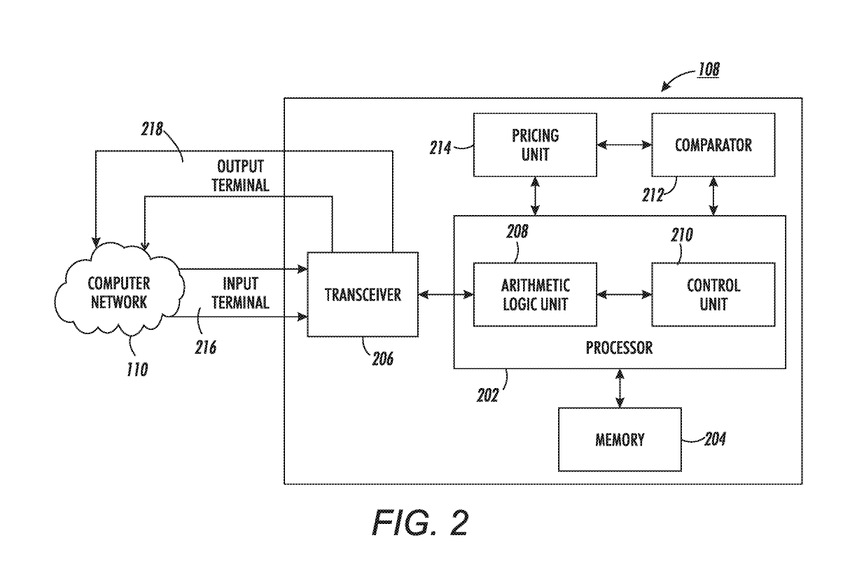

FIG. 2 is a block diagram that illustrates a system for determining cost of one or more computational resources, in accordance with at least one embodiment. For the purpose of ongoing description, the system is considered as the marketplace server 108.

The marketplace server 108 may include one or more processors, such as a processor 202, one or more memories, such as a memory 204, one or more transceivers, such as a transceiver 206, one or more comparators, such as a comparator 212, and one or more pricing units, such as a pricing unit 214. The transceiver 206 may be coupled with an input terminal 216 and an output terminal 218. Further, the transceiver 206 may be connected to the computer network 110, via the input terminal 216 and the output terminal 218.

The processor 202 may comprise suitable logic, circuitry, interfaces, and/or codes that may be configured to execute one or more sets of instructions stored in the memory 204. The processor 202 may be coupled to the memory 204, the transceiver 206, the comparator 212, and the pricing unit 214. The processor 202 may further include an arithmetic logic unit (ALU) 208 and a control unit 210. The ALU 208 may be coupled to the control unit 210. The ALU 208 may be configured to perform one or more mathematical and logical operations and the control unit 210 may be operable to control the operation of the ALU 208. The processor 202 may execute the one or more sets of instructions, programs, codes, and/or scripts stored in the memory 204 to perform the one or more predefined operations. The processor 202 may be implemented based on a number of processor technologies known in the art. Examples of the processor 202 include, but are not limited to, an X86-based processor, a Reduced Instruction Set Computing (RISC) processor, an Application-Specific Integrated Circuit (ASIC) processor, and/or a Complex Instruction Set Computing (CISC) processor, a microprocessor, a microcontroller, and/or the like.

The memory 204 may comprise suitable logic, circuitry, and/or interfaces that may be operable to store one or more machine codes, and/or computer programs having at least one code section executable by the processor 202 and/or the pricing unit 214. The memory 204 may further be configured to store the one or more sets of instructions, codes, and/or scripts. In an embodiment, the memory 204 may include one or more buffers (not shown). The one or more buffers may be configured to store at least one or more of, but are not limited to, the first information, the second information, the first cost and the second cost determined for a time epoch. The one or more buffers may further store the information pertaining to the one or more available/required computational resources. Some of the commonly known memory implementations include, but are not limited to, a random access memory (RAM), a read only memory (ROM), a hard disk drive (HDD), and a secure digital (SD) card. In an embodiment, the memory 204 may include the one or more machine codes, and/or computer programs that are executable by the processor 202 to perform the one or more predefined operations. It will be apparent to a person having ordinary skill in the art that the one or more sets of instructions, programs, codes, and/or scripts stored in the memory 204 may enable the hardware of the marketplace server 108 to perform the one or more predefined operations.

The transceiver 206 may comprise suitable logic, circuitry, and/or interfaces that may be operable to communicate with the one or more devices, such as the resource provider computing device 102 or the requestor computing device 104 and/or one or more servers, such as the database server 106 over the computer network 110. The transceiver 206 may be operable to transmit or receive the instructions, the queries, the one or more requests, the one or more available/required computational resources, the first information and/or other information to/from various components of the system environment 100. In an embodiment, the transceiver 206 may be coupled to the input terminal 216 and the output terminal 218 through which the transceiver 206 may receive or transmit the instructions, the queries, the one or more requests, the one or more available/required computational resources, the first information, the second information and/or the other information corresponding to the determination of the cost of the one or more available/required computational resources. In an embodiment, the transceiver 206 may receive and/or transmit various data and information in accordance with various communication protocols such as, TCP/IP, UDP, and 2G, 3G, or 4G communication protocols through the input terminal 216 and/or the output terminal 218.

The comparator 212 may comprise suitable logic, circuitry, and/or interfaces that may be configured to compare at least two input signals to generate an output signal. In an embodiment, the output signal may correspond to either “1” or “0.” In an embodiment, the comparator 212 may generate an output “1” if a value of a first signal (from the at least two signals) is greater than a value of a second signal (from the at least two signals). Similarly, the comparator 212 may generate an output “0” if the value of the first signal is less than the value of the second signal. In an embodiment, the comparator 212 may be realized through either software technologies or hardware technologies known in the art. Though, the comparator 212 is depicted as independent from the processor 202 in FIG. 2, a person skilled in the art will appreciate that the comparator 212 may be implemented within the processor 202 without departing from the scope of the disclosure.

The pricing unit 214 may comprise suitable logic, circuitry, interfaces, and/or code that may be configured to execute one or more sets of instructions, codes, and programs stored in the memory 204. The pricing unit 214 may be realized by use of one or more mathematical models, one or more statistical models and/or one or more algorithms, which may enable the determination of the cost (the first cost and the second cost) of the one or more required/available computational resources. Though, the pricing unit 214 is depicted as independent from the processor 202 in FIG. 2, a person skilled in the art will appreciate that the pricing unit 214 may be implemented within the processor 202 without departing from the scope of the disclosure. Further, a person skilled in the art will appreciate that the processor 202 may be configured to perform the functionalities of the pricing unit 214 without departing from the scope of the disclosure. In an embodiment, the pricing unit 214 may be implemented as the ASIC or FPGA.

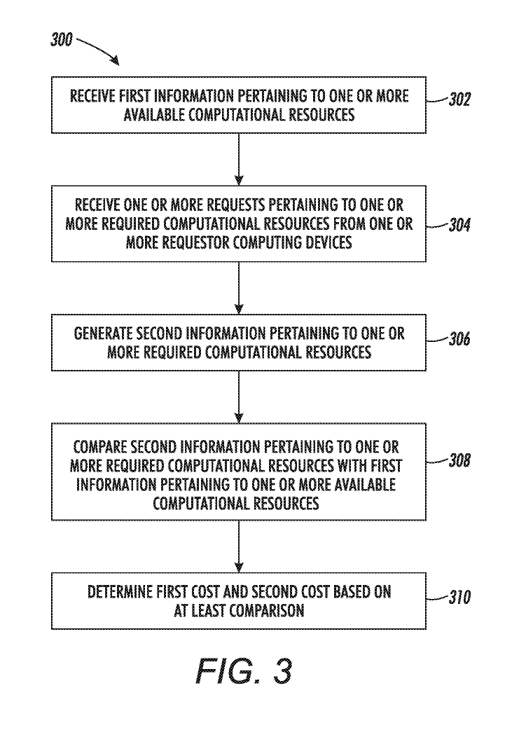

FIG. 3 is a flowchart that illustrates a method of cost determination of one or more computational resources, in accordance with at least one embodiment. The flowchart 300 has been described in conjunction with elements of FIG. 1 and FIG. 2.

At step 302, the first information pertaining to the one or more available computational resources is received. The first information may include, but are not limited to, a type, a capacity, and a time period associated with the one or more available computation resources. In an embodiment, the transceiver 206 may be configured to receive the first information, pertaining to the one or more available computational resources, from the resource provider computing device 102. For example, the first information associated with the one or more available computational resources may include one or more of: processor instances, storage space (100 GB OR 1000 GB), processing power (4 GHz or 8 GHz), and RAM space (8 GB or 12 GB). In an embodiment, the one or more resource providers may be interested to sell, rent, or share the one or more available computational resources to the one or more consumers (i.e., the one or more requestors). In an embodiment, the first information may further include the information pertaining to the first threshold cost and/or the second threshold cost associated with each of the one or more available computational resources. The first threshold cost may correspond to the minimum cost that may be charged by the one or more resource providers for renting, selling, or sharing the one or more available computational resources with the marketplace server 108 or the one or more requestors. The second threshold cost may correspond to the maximum cost that may be charged by the one or more resource providers for renting, selling, or sharing the one or more available computational resources with the marketplace server 108 or the one or more requestors.

In an embodiment, each of the one or more computational resources may be associated with one or more types. For example, the one or more types of the one or more computational resources may include one or more of, but are not limited to, a first type resource (processor instances), a second type resource (storage space), a third type resource (processing power), a fourth type resource (RAM space), and/or the like. In another embodiment, the one or more types of the one or more computational resources may be determined based on one or more types of the one or more requests. The one or more types of the one or more requests have been discussed in conjunction with step 304.

After receiving the first information associated with the one or more available computational resources, the transceiver 206 may store the first information in the memory 204.

At step 304, the one or more requests are received from the one or more requestor computing devices. The one or more requests may correspond to the one or more computational resources that are required for processing the one or more tasks. In an embodiment, the transceiver 206 may be configured to receive the one or more requests from the one or more requestor computing devices, such as the requestor computing device 104 over the computer network 110. In an embodiment, the one or more requests may include the one or more tasks to be executed, data pertaining to the type of the one or more tasks to be executed, a third threshold cost and a fourth threshold cost that the one or more requestors are willing to pay for the one or more computational resources that may be required to get the one or more tasks executed or processed. The third threshold cost may correspond to the minimum cost that the one or more requestors may be willing to pay for the one or more required computational resources. The fourth threshold cost may correspond to the maximum cost that the one or more requestors may be willing to pay for the one or more required computational resources.

For example, a requestor transmits a request pertaining to processing of an image processing task. In such a case, the requestor may require one or more of: processor, storage, software, and/or the like to process the image processing task. In an embodiment, the one or more requests may further include interests of the one or more requestors either for buying, renting, or sharing the one or more required computational resources for a predefined time duration.

In an embodiment, the one or more requests may be associated with the one or more types. The one or more types of the one or more requests may be determined based on at least the task associated with each of the one or more requests. For example, a first request, which corresponds to an image processing task, may be referred to as a first type request. In another example, a second request, which corresponds to a video processing task, may be referred to as a second type.

After receiving the one or more requests for processing the one or more tasks, the transceiver 206 may store the one or more requests in the memory 204. Based on the one or more requests, the processor 202 may generate the second information.

At step 306, the second information pertaining to the one or more required computational resources is generated. In an embodiment, the processor 202 may be configured to generate the second information for each of the one or more time epochs. The second information may correspond to requirements (e.g., type, capacity, quantity, and/or the like) of the one or more requestors for the one or more computational resources.

Prior to generating the second information, the processor 202 may be configured to divide a predefined time period into the one or more time epochs. A time epoch may correspond to a time period during which the first cost and the second cost of the one or more required computational resources and the one or more available computational resources, respectively, are constant. For example, consider a predefined time period between 9 AM to 9 PM, i.e., 12 hours. Based on a predefined instructions or an input from an administrator of the marketplace server 108, the processor 202 may divide the predefined time period into a predefined number of time epochs (e.g., six time epochs). In such a case, the time period of each of the six time epochs will be equal to 2 hours.

During each time epoch, the processor 202 may receive the one or more requests, and the first information pertaining to the one or more available computational resources. In an embodiment, the one or more requests received during a time epoch are processed in the temporally next time epoch of the one or more time epochs.

Thereafter, at the beginning of each time epoch, the processor 202 may generate the second information based on the at least the corresponding one or more received requests. For each of the one or more requests, the processor 202 may translate the data received in the request to the second information. In an embodiment, the processor 202 may employ one or more benchmarking techniques to translate the data, received in the request, to the second information. As discussed supra, the second information comprises information pertaining to the capacity of the one or more required computational resources. For instance, the capacity of the one or more required computational resources may include, clock speed of the processor, amount of RAM requires, storage space required, etc.

For example, a request received from the requestor computing device 104 includes an image processing task. Further, the data pertaining to the request comprises information pertaining to the type of task, which in this example is the image processing task. In an embodiment, the processor 202 may utilize this information or the data to generate the second information. For example, the processor 202 may utilize the one or more benchmarking techniques to determine that the image processing task requires 2 GHz of CPU, 1 GB graphics memory, 2 GB RAM, and 10 GB storage space.

In an alternate embodiment, the request received from the requestor computing device 104 may include the second information along with the task. In such a scenario, the processor 202 need not generate the second information. The processor 202 may directly utilize the second information to determine the one or more required computational resources. For example, a requestor transmits a request to the marketplace server 108 during a first time epoch. The request states “want to create a VDI environment on five computing devices in my home to process one or more tasks, such as video/image/document processing tasks”. For example, the second information pertaining to the creation of the VDI environment for processing the video/image/document processing tasks may include Windows 7, 64-bit, 20 GB RAM, and 150 GB storage space.

After determining the second information, the processor 202 may present a user interface on the requestor computing device 104 of each of the one or more requestors. The user interface may be configured to display the generated second information pertaining to the one or more requests. Post approval or modification in the generated second information by the one or more requestors, the processor 202 may further be configured to determine the cost of the one or more required computational resources. In another embodiment, the processor 202 may determine the cost of the one or more required computational resources after generating the second information. In such a case, the processor 202 may not present the user interface, displaying the generated second information, to the one or more requestors.

At step 308, the second information pertaining to the one or more required computational resources is compared with the first information pertaining to the one or more available computational resources. In an embodiment, the comparator 212 may be configured to compare the second information with the first information during each of the one or more time epochs. As discussed supra, that during the each time epoch, the processor 202 may generate the second information and may receive the first information. Therefore, the comparison between the first information and the second information may be different in each time epoch.

Based on the comparison, the processor 202 may determine whether the one or more available computational resources will be able to fulfill the requirement for the one or more computational resources (i.e., the one or more required computational resources). For example, following table illustrates the first information:

TABLE 1
Illustrative example of first information

| Resource Provider | First information |
|---|---|
| Resource provider-1 | 4-cores of processor, 20 GB RAM, 500 GB HDD |
| Resource provider-2 | 1-core processor, 10 GB RAM, 100 GB HDD, and |
| | 1 GB graphics |

Further, for instance, the second information generated by the processor 202 is 1-core processor, 1 GB RAM, 512 GB graphics, and 19 GB HDD. In such a scenario, the processor 202 may determine that the one or more available computational resources will be able to full fill the required computational resources (in the second information). If the second information included that 2 GB graphics are required, the processor 202 may determine that the one or more available computational resources may not be able to fulfill the required computational resources.

At step 310, the first cost and the second cost are determined. The first cost corresponds to a price that is offered to the one or more requestors for the one or more required computational resources. The second cost corresponds to a price that is offered to the one or more resource providers for providing the one or more available computational resources. In an embodiment, the pricing unit 214 may be configured to determine the first cost and the second cost based on at least the comparison between the first information and the second information.

At the beginning of each of the one or more time epochs, the pricing unit 214 may be configured to determine the first cost and the second cost, such that a net profit of an entity associated with the marketplace server 108 is maximized. In an embodiment, the following equation indicates the profitability of the marketplace server 108:

Profit: ΣᵢpᵢDᵢ(p|r)−ΣⱼcⱼΣᵢDᵢⱼ(p₁, p₂, . . . , pₖ|r₁(t), r₂ (t), . . . , rₖ(t)) (1)

where,

k: Types of requests (e.g., based on type of tasks, e.g., image processing tasks, video processing tasks, etc.);

c=c₁, . . . , cₙ: Second cost per computational resource type in a time epoch;

p=p₁,. . . , pₙ: First cost for each type of request;

r=r₁, . . . , rₙ: Current demand for various requests;

Dᵢ(p|r): Expected demand for request of type i, when market request is r and first cost is p;

Dᵢⱼ(p, c|r): Requirement of resource of type j by rᵢ requests of type i, when first cost is p and second cost is c; and

n: Types of resources (e.g., storage type, RAM type, Processing power type, etc.).

In order to determine the first cost (or the second cost) for a time epoch, the processor 202 may determine the fourth threshold cost (or the second threshold cost) from the received request. As discussed, the fourth threshold cost corresponds to the maximum cost received in the request. Further, the processor 202 may determine the first cost of the request from previous time epoch. Thereafter, based on the fourth threshold cost and the first cost from the previous time epoch, the processor 202 may determine the expected demand for the request type i (Dᵢ(p|r)). In an embodiment, the processor 202 may utilize the following equation to determine Dᵢ(p|r).

$${D}_{i} ( p \vert r ) = \frac{diff ( i )}{\sum diff ( i )} \qquad ( 2 )$$

where,

diff (i):difference between the current first cost and the fourth threshold cost for a request type i.

Further, the processor 202 may determine the requirement of the resource type j (Dᵢⱼ(p, c|r)) based on normal distribution of the second cost with a predetermine variance and third threshold of the second cost.

Thereafter, the processor 202 may formulate a dynamic optimization problem as shown in equation 1, such that a solution of the dynamic optimization problem maximizes the net profit of the marketplace server 108.

After formulating the dynamic optimization problem, the pricing unit 214 may utilize a sequential optimization algorithm to solve the dynamic optimization problem. Prior to solving the dynamic optimization problem, the processor 202 may be configured to rank the one or more requests for the one or more required computational resources based on a count of requests for the one or more required computational resources. For example, the one or more requests are arranged sequentially in decreasing order of current demand, i.e., r₁(t)≧r₂(t) . . . ≧rₖ(t). Further, in an embodiment, the processor 202 may rank the one or more available computational resources based on a count of resource providers providing each available computational resource of the one or more available computational resources or based on the supply quantity associated with each of the one or more available computational resources. For example, the one or more computational resources are ranked in the order of their supply, i.e., type 1 resource is most abundant and type n resource will be lowest supply. Thereafter, the pricing unit 214 may utilize the sequential optimization algorithm to determine the first cost and the second cost. In an embodiment, the pricing unit 214 may optimize each of pᵢ, cⱼ sequentially assuming remaining parts to be constant and hence running time of the sequential optimization algorithm is o((n+k)M), where M=max(maxᵢhᵢ/δ, maxⱼhⱼ/δ).

In an embodiment, the sequential optimization algorithm may be realized using one or more pseudo-codes. The one or more pseudo-codes may be processed by a computing device, such as the marketplace server 108, to determine the first cost and the second cost. For example, the one or more pseudo-codes that may be utilized to determine the first cost and the second cost, and further maximizing the net profit of the marketplace server 108 are mentioned below:
Inputs: current epoch demand of requests r=(r₁(t),r₂(t), . . . , rₖ(t)), current epoch cost (first cost) vector p=(p₁(t),p₂(t), . . . , pₖ(t)), current epoch cost (second cost) vector c=(c₁(t), c₂(t), . . . , cₖ(t)).
Output: price vector p₁(t+1), p₂ (t+1), . . . , pₖ(t+1) and charges vector c₁(t+1), c₂(t+1), . . . , cₖ(t+1) for next epoch.
   1. fix prices as p₂=p₂(t), . . . , pₖ=pₖ(t) to be current prices and payment for resources to be current payment vector c=(c₁(t), c₂(t), . . . , cₖ(t))
   2. p₁(t+1)=argmaxₚ_{₁},ΣᵢpᵢDᵢ(p|r)−ΣⱼcⱼΣᵢDᵢⱼ(p₁,p₂, . . . ,pₖ,c|r)
   3. l=2 to k
   4. p₁=p₁(t+1), . . . , pᵢ₋₁=p_{i'11}(t+1), pᵢ₊₁=pᵢ₊₁(t), . . . , pₖ=pₖ(t)
   5. pᵢ(t+1)=argmaxₚ_{ᵢ}ΣᵢpᵢDᵢ(p|r)−ΣⱼcⱼΣᵢDᵢⱼ(P₁,p₂, . . . , pₖ, c|r)
   6. fix payments for c₂=c₂(t), . . . , cₖ=cₖ(t) and price vector to be p=p(t+1)
   7. c₁(t +1)=argmax_{c}_{₁}ΣᵢpᵢDᵢ(p|r)−Σᵢ EⱼcⱼDᵢⱼ(p₁,p₂, . . . , pₖ,c|r)
   8. for j=2 to n
   9. c₁=c₁(t+1), . . . , cⱼ₋₁=cⱼ₋₁(t+1), cⱼ₊₁=cⱼ₊₁(t), . . . , cₙ=cₙ(t)
   10. cⱼ(t+1)=argmax_{c}_{ⱼ}ΣᵢpᵢDᵢ(p|r)−ΣⱼcⱼΣᵢDᵢⱼ(p₁,p₂, . . , pₖ, c|r)

In an embodiment, the first cost and the second cost in each time epoch are updated based on the probability of acceptance of the first cost by the one or more requestors and the probability of acceptance of the second cost by the one or more resource providers, respectively. A person having ordinary skills in the art will agree with the statement that “higher a price of a resource, lower is a probability that a requestor will accept it”. Therefore, the probability of acceptance of a cost (i.e., the first cost or the second cost) may be determined by use of the following instructions: Categorize the one or more computational resources (required or available) into one or more categories based on at least the requirement, capacity, type, time duration, and/or the like. For example,

TABLE 2
Exemplary table showing categorization of resources

| Memory Requirement/Capacity | Category |
|---|---|
| 0-4 GB | 0 |
| 4-8 GB | 1 |
| 8-16 GB | 2 |

Further, each of the one or more categories are associated with a minimum cost and a mayimiim onct Fnr ovamnlo

TABLE 3
Exemplary table showing cost variations

Cost Range

| Category | Minimum Cost (USD) | Maximum Cost (USD) |
|---|---|---|
| 0 | 5 | 10 |
| 1 | 3 | 7 |
| 2 | 2 | 5 |

In an embodiment, the pricing unit 214 may utilize the normally distributed values with a predefined variance (e.g., 0.2) and mean as lower limit to determine the probability of acceptance of the second cost. Further, in an embodiment, the processor 202 in conjunction with the pricing unit 214 may be configured to determine the first cost and the second cost, such that an inherent trade-off in supply maximization and demand maximization is handled while maximizing the net profit of the entity associated with the marketplace server 108.

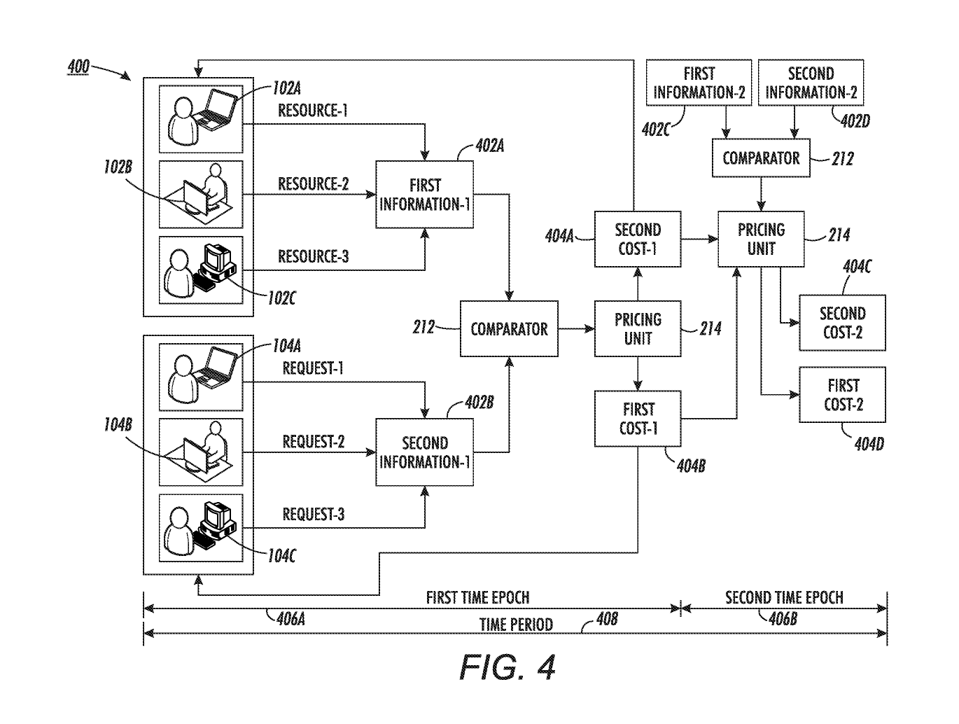

FIG. 4 is an exemplary flow diagram 400 for determining cost (first cost and second cost) of one or more computational resources in one or more time epochs, in accordance with at least one embodiment. The flow diagram 400 has been described in conjunction with elements of FIG. 1, FIG. 2 and FIG. 3.

The one or more resource providers utilizes one or more resource provider computing devices (denoted by 102A, 102B, and 102C) to transmit first information-1 (denoted by 402A) to the marketplace server 108 over the computer network 110. The first information-1 may correspond to information associated with one or more available resources (e.g., resource-1, resource-2, and resource-3). Further, the one or more requestors utilizes one or more requestor computing devices (denoted by 104A, 104B, and 104C) to transmit one or more requests (e.g., request-1, request-2, and request-3). Based on the received one or more requests at the beginning of a first time epoch (denoted by 406A) of a time period (denoted by 408), the processor 202 generates second information-1 (denoted by 402B). The comparator 212 compares the first information-1 (denoted by 402A) with the second information-1 (denoted by 402B). Based on at least the comparison, the processor 202 determines whether there is a shortage of one or more required resources. Further, based on at least the comparison, the pricing unit 214 determines a first cost-1 (denoted by 404B) and a second cost-1 (denoted by 404A) in the first time epoch (denoted by 406A). Prior to determining the first cost-1 (denoted by 404B) and the second cost-1 (denoted by 404A), the pricing unit 214 may formulate a dynamic optimization problem as discussed above in conjunction with FIG. 3. Thereafter, the pricing unit 214 may further utilize one or more algorithms, programs, and/or pseudo codes (e.g. sequential optimization algorithm) to solve the dynamic optimization problem, such that a net profit of the marketplace server 108 is optimized.

After determining the first cost-1 (denoted by 404B) and the second cost-1 (denoted by 404A), the processor 202 may display the first cost-1 (denoted by 404B) and the second cost-1 (denoted by 404A) on display screen of the one or more requestor computing devices and the one or more resource provider computing devices, respectively.

The processor 202 further receives first information-2 (denoted by 402C) and second information-2 (denoted by 402D) during a second time epoch (denoted by 406B) in the time period (denoted by 408). The comparator 212 compares the first information-2 (denoted by 402C) and the second information-2 (denoted by 402D). Based on at least the comparison, the first cost-1 (denoted by 404B) and the second cost-1 (denoted by 404A), the pricing unit 214 determines a first cost-2 (denoted by 404D) and a second cost-2 (denoted by 404C) in the second time epoch (denoted by 406B). Prior to determining the first cost-2 (denoted by 404D) and the second cost-2 (denoted by 404C), the pricing unit 214 may formulate a dynamic optimization problem based on at least the first information-2 (denoted by 402C), the second information-2 (denoted by 402D), the first cost-2 (denoted by 404D) and/or the second cost-2 (denoted by 404C). Thereafter, the pricing unit 214 may further utilize one or more algorithms, programs, and/or pseudo codes (e.g. the sequential optimization algorithm) to solve the dynamic optimization problem, such that a net profit of the marketplace server 108 is optimized.

The disclosed embodiments encompass numerous advantages. Various embodiments of the disclosure may facilitate a shared service marketplace to dynamically determine a first cost offered to one or more requestors for one or more required computational resources and a second cost offered to one or more resource providers for providing one or more required computational resources. Further, the first cost and the second cost are constant during a time epoch. The shared service marketplace determines the first cost and the second cost in each time epoch in a manner that satisfies the one or more requestors (best first cost) and the one or more resource providers (best second cost) while still maximizing a net profit for the shared service marketplace.

The present disclosure may be realized in hardware, or a combination of hardware and software. The present disclosure may be realized in a centralized fashion, in at least one computer system, or in a distributed fashion, where different elements may be spread across several interconnected computer systems. A computer system or other apparatus adapted for carrying out the methods described herein may be suited. A combination of hardware and software may be a general-purpose computer system with a computer program that, when loaded and executed, may control the computer system such that it carries out the methods described herein. The present disclosure may be realized in hardware that comprises a portion of an integrated circuit that also performs other functions.

The present disclosure may also be embedded in a computer program product, which comprises all the features enabling the implementation of the methods described herein, and which when loaded in a computer system is able to carry out these methods. Computer program, in the present context, means any expression, in any language, code or notation, of a set of instructions intended to cause a system having an information processing capability to perform a particular function either directly, or after either or both of the following: a) conversion to another language, code or notation; b) reproduction in a different material form.

Various embodiments of the methods and systems for cost determination of one or more computational resources have been disclosed. While the present disclosure has been described with reference to certain embodiments, it will be understood by those skilled in the art that various changes may be made and equivalents may be substituted without departing from the scope of the present disclosure. In addition, many modifications may be made to adapt a particular situation or material to the teachings of the present disclosure without departing from its scope. Therefore, it is intended that the present disclosure not be limited to the particular embodiment disclosed, but that the present disclosure will include all embodiments falling within the scope of the appended claims. Moreover, in interpreting the disclosure, all terms should be understood in the broadest possible manner consistent with the context. In particular, the terms “comprises” and “comprising” should be interpreted as referring to elements, components, or steps, in a non-exclusive manner, indicating that the referenced elements, components, or steps may be present, or utilized, or combined with other elements, components, or steps that are not expressly referenced.

A person having ordinary skills in the art will appreciate that the system, modules, and sub-modules have been illustrated and explained to serve as examples and should not be considered limiting in any manner. It will be further appreciated that the variants of the above disclosed system elements, or modules and other features and functions, or alternatives thereof, may be combined to create other different systems or applications.

Those skilled in the art will appreciate that any of the aforementioned steps and/or system modules may be suitably replaced, reordered, or removed, and additional steps and/or system modules may be inserted, depending on the needs of a particular application. In addition, the systems of the aforementioned embodiments may be implemented using a wide variety of suitable processes and system modules and is not limited to any particular computer hardware, software, middleware, firmware, microcode, or the like.

It will be appreciated that variants of the above disclosed, and other features and functions or alternatives thereof, may be combined into many other different systems or applications. Presently unforeseen or unanticipated alternatives, modifications, variations, or improvements therein may be subsequently made by those skilled in the art, which are also intended to be encompassed by the following claims.

What is claimed is:

1. A method of cost determination of one or more computational resources, said method comprising:
in a marketplace server:
receiving, by one or more processors, a first information pertaining to one or more available computational resources from one or more resource provider computing devices;
receiving, by said one or more processors, one or more requests pertaining to one or more required computational resources from one or more requestor computing devices; and
for a time epoch from one or more time epochs:
generating, by said one or more processors, a second information pertaining to said one or more required computational resources based on said one or more requests;
comparing, by said one or more processors, said second information pertaining to said one or more required computational resources with said first information pertaining to said one or more available computational resources; and
determining, by said one or more processors, a first cost offered to one or more requestors for said one or more required computational resources and a second cost offered to one or more resource providers for providing said one or more required computational resources based on at least said comparison, and said first cost and said second cost associated with said one or more required computational resources in a previous time epoch.

2. The method of claim 1 further comprising updating, by said one or more processors, said first cost for each of said one or more required computational resources based on a probability of acceptance of said first cost by said one or more requestors.

3. The method of claim 2 further comprising updating, by said one or more processors, said second cost for each of said one or more available computational resources based on a probability of acceptance of said second cost by said one or more resource providers.

4. The method of claim 3, wherein said first cost and said second cost are determined based on at least said one or more available computational resources and said one or more required computational resources.

5. The method of claim 1 further comprising ranking, by said one or more processors, said one or more requests for said one or more required computational resources based on a count of requests for said one or more required computational resources.

6. The method of claim 5 further comprising ranking, by said one or more processors, each available computational resource of said one or more available computational resources based on a count of resource providers providing said each available computational resource of said one or more available computational resources.

7. The method of claim 6 further comprising maximizing, by said one or more processors, a net profit of an entity associated with said marketplace server based on at least said ranking, said first cost, and said second cost.

8. The method of claim 7, wherein each of said first cost and said second cost are associated with a minimum threshold cost and a maximum threshold cost.

9. A system for determining cost of one or more computational resources, said system comprising:
one or more processors in a marketplace server configured to:
receive a first information pertaining to one or more available computational resources from one or more resource provider computing devices;
receive one or more requests pertaining to one or more required computational resources from one or more requestor computing devices; and
for a time epoch from one or more time epochs:
generate said one or more processors, a second information pertaining to said one or more required computational resources based on said one or more requests;
compare said second information pertaining to said one or more required computational resources with said first information pertaining to said one or more available computational resources; and
determine a first cost offered to said one or more requestors for said one or more required computational resources and a second cost offered to one or more resource providers for providing said one or more required computational resources based on at least said comparison, and said first cost and said second cost associated with said one or more required computational resources in a previous time epoch.

10. The system of claim 9, wherein said one or more processors are further configured to update said first cost based on a probability of acceptance of said first cost by said one or more requestors.

11. The system of claim 10, wherein said one or more processors are further configured to update said second cost based on a probability of acceptance of said second cost by said one or more resource providers.

12. The system of claim 11, wherein said one or more processors are further configured to determine said first cost and said second cost based on at least said one or more available computational resources and said one or more required computational resources.

13. The system of claim 9, wherein said one or more processors are further configured to rank said one or more requests for said one or more required computational resources based on a count of requests for said one or more required computational resources.

14. The system of claim 13, wherein said one or more processors are further configured to rank each available computational resource of said one or more available computational resources based on a count of resource providers providing said each available computational resource of said one or more available computational resources.

15. The system of claim 14, wherein said one or more processors are further configured to maximize a net profit of an entity associated with said marketplace server based on at least said ranking, said first cost, and said second cost.

16. The system of claim 15, wherein each of said first cost and said second cost are associated with a minimum threshold cost and a maximum threshold cost.

17. A computer program product for use with a computer, the computer program product comprising a non-transitory computer readable medium, wherein the non-transitory computer readable medium stores a computer program code for determining cost of one or more computational resources, wherein the computer program code is executable by one or more processors to:
receive a first information pertaining to one or more available computational resources from one or more resource provider computing devices;
receive one or more requests pertaining to one or more required computational resources from one or more requestor computing devices; and
for a time epoch from one or more time epochs:
generate said one or more processors, a second information pertaining to said one or more required computational resources based on said one or more requests;
compare said second information pertaining to said one or more required computational resources with said first information pertaining to said one or more available computational resources; and
determine a first cost offered to said one or more requestors for said one or more required computational resources and a second cost offered to one or more resource providers for providing said one or more required computational resources based on at least said comparison, and said first cost and said second cost associated with said one or more required computational resources in a previous time epoch.
